(19) United States
(12) Patent Application Publication
(10) Pub. No.: US 2008/0015743 A1
(43) Pub. Date: Jan. 17, 2008

(54) Method and system for assisting the driver of a motor vehicle in identifying road bumps

(76) Inventor: Karsten Haug, Stuttgart (DE)

Correspondence Address: KENYON & KENYON LLP, ONE BROADWAY, NEW YORK, NY, 10004, US

(21) Appl. No.: 11/824,098

(22) Filed: Jun. 28, 2007

(30) Foreign Application Priority Data
Jun. 30, 2006 (DE) 10 2006 030178.1

(51) Int. Cl. G06F 17/00

(52) U.S. Cl. 701/1; 340/540

(57) ABSTRACT

A system and method for assisting the driver of a vehicle in identifying obstacles for the vehicle as is described. Objects located outside the vehicle are detected with the aid of object detector. If objects are detected, information is given to the driver and/or to defined components of the vehicle. An evaluation unit ascertains whether a detected object is a road bump, and information is given to the driver and/or to components of the vehicle only if a detected object is a road bump.

### FIELD OF THE INVENTION

The present invention relates to a method for assisting the driver of a vehicle in identifying obstacles for the vehicle, objects located outside the vehicle being detected with the aid of object detection means and, if objects are detected, information is given to the driver and/or to defined components of the vehicle.

### BACKGROUND INFORMATION

Methods of this type are known within driver assistance systems in motor vehicles. They are to assist the driver in driving the vehicle by pointing out possible obstacles for the vehicle in addition to his own perception and in particular warning him of imminent dangers or collisions.

German Patent Application No. DE 103 59 413 A1 describes a system and a method for collision warning in motor vehicles in which objects located outside the vehicle are detected and displayed in a display unit.

Possible obstacles for a vehicle also include road bumps built into the road intentionally as speed bumps to force the driver to reduce the driving speed. Such road bumps, known as speed humps, may be designed as sinusoidal waves or bumps, but also having front and back ramps and different heights. They force the driver to drive over them at a reduced speed to minimize vibrations of the vehicle and the occupants and avoid damage to the vehicle, in particular to the shock absorbers. Normally, such road bumps are used on streets where children are at play, in residential areas or, in some countries, for example, in Mexico, India, or Turkey, at points of entry into towns to prevent high-speed driving in the area of the road bump and remind the driver that he must check and possibly adjust his speed also in the following area.

Yet it may happen that the driver fails to notice a road bump, in particular in complex driving situations. Especially when trying to find his way in strange cities and due to general distraction sources such as fellow passengers or in the event of tiredness, there is the danger that a road bump is not noticed in a timely manner or at all and the driver drives over it at an excessive speed. Also, at night or under poor visibility conditions, there is an increased risk that a road bump is not recognized by the driver, especially if color markings such as white zig-zag lines fade over time and are unable to adequately fulfill their desired warning function.

In addition to the strong vibrations caused thereby to the vehicle and the passengers, chassis components may also be damaged. More importantly, the service life of the shock absorbers is considerably reduced. Since, if the vehicle is driven over a road bump at an unadjusted speed, it partially loses contact with the ground, the braking distance of an initiated or ongoing braking maneuver becomes longer. In the worst case, the vehicle may become fully uncontrollable.

### SUMMARY

An object of the present invention is to provide an improved method, i.e., driver assistance system of the above-mentioned type, which would strongly support the driver in detecting obstacles for the vehicle and minimize or even completely prevent the risk of driving over road bumps at an excessive speed and the resulting consequences.

According to the present invention, a detected obstacle is evaluated with the aid of an evaluation unit regarding whether it is a road bump, and corresponding information is output to the driver and/or to components of the vehicle only if a detected object has been identified as a road bump.

Compared to conventional methods and systems, the example method may have the advantage that the driver is effectively assisted when road bumps or speed bumps are identified. The risk of overlooking a road bump built into the road for limiting the vehicle speed is thus considerably reduced. Subsequent damage resulting from driving over a road bump at an excessive speed may thus be avoided or at least considerably reduced, which contributes to overall traffic safety.

It is thus advantageous in particular if the output of information to the driver and/or to components of the vehicle is suppressed, in spite of a road bump having been detected, if the instantaneous speed of the vehicle is lower than a predefined limit speed or maximum speed, so that there is no risk of driving over the road bump at an excessive speed, and/or if the driver himself has already initiated a braking operation of the vehicle and has significantly reduced the speed of the vehicle, so that it may be assumed that the driver has already recognized an upcoming road bump and has initiated the necessary measures. Unnecessary signals or information are thus avoided, so that the driver may dedicate his full attention to the traffic. The limit speed depends on the type of vehicle and may be 15 km/h, for example. It may also be selected or set by the driver as a function of the normal types and heights of road bumps in the given area.

The predefined maximum speed may advantageously also be a function of the type, in particular the height, of a recognized road bump. For this purpose, a certain feature, preferably the height of a detected road bump, is determined with the aid of the object detector, and the maximum or limit speed assigned to the ascertained feature or its value is derived with the aid of a characteristic curve or a mathematical function, which is preferably adjusted to the particular vehicle.

According to a particularly preferred specific embodiment of method according to the present invention, it is furthermore provided that the vehicle, the drive and/or the braking device of the vehicle in particular, be controlled or regulated in such a way that the speed of the vehicle is automatically reduced if the evaluation of a detected object yields the result that it is a road bump built as a speed bump. The vehicle is then preferably braked to a predefined or predefinable maximum speed, which is a function of the type of the vehicle and/or, as described above, of the type, in particular the height, of a recognized road bump. The advantages are manifested in particular in the driver being further unburdened, since he no longer has to initiate braking himself after a road bump has been detected. Time delays due to the driver's response time are also avoided.

A particularly advantageous embodiment of the method according to the present invention which may be used in vehicles having an active chassis or similar equipment provides that, if a road bump has been detected, the active chassis of the vehicle is automatically adjusted to driving over the upcoming bump on the road in an optimum way, i.e., with the least possible negative effect on the vehicle and the occupants. Within this adjustment, the road clearance of the vehicle may be preferably increased and/or the suspension may be made softer.

The automatically effected adjustments may advantageously also depend on the instantaneous driving speed.

It is furthermore advantageous in particular if the drive and/or the active chassis of the vehicle is controlled in such a way that after passing a detected road bump the vehicle is accelerated again and/or the active chassis of the vehicle is set again to a road bump-free stretch, the operating parameters which existed before the detection of the road bump being preferably set again. For example, the vehicle is preferably accelerated to the speed at which it was driven immediately before automatic braking was initiated. An automatic pre-tensioning of an active chassis for driving over a detected road bump may be canceled after passing over the road bump so that travel may be resumed under the previous conditions. The operating parameters may also be advantageously reset automatically after passing over a road bump depending on the driver previously entering an appropriate release signal, which may take place by actuating a button and/or by actuating the gas pedal.

When a road bump has been detected, information may be advantageously generated for the driver in the form of one or more warning signals, which may be preferably output as visual and/or acoustic and/or haptic warning signals. For a haptic warning, human/machine interfaces (HMI) may be used, which may already be present in the vehicle within a Lane Departure Warning System (LDW). These include, for example, vibrators in the steering wheel or the seat, via which a short warning pulse may be generated.

An even more efficient warning is possible by a short braking pressure automatically generated after a detected road bump, such as by PSS (Predictive Safety Systems). This short braking pressure results in the driver himself starting to brake after a very short delay. Warning lights in a combo instrument, for example, as visual information, may indicate a detected road bump. It is advantageous in particular in the case of visual information if, in the event of a road bump being detected, a picture or a symbol of a road bump, advantageously with its correct location, is inserted into a video display system of the vehicle, for example, a night vision system. The picture or symbol may preferably be additionally highlighted by a marking such as a red frame.

According to another, particularly preferred specific embodiment of the method according to the present invention, it is proposed that at least one defined feature of a detected road bump is ascertained and compared with a predefined or predefinable comparative quantity and that the output of information to the driver and/or to components of the vehicle is a function of the result of this comparison. The height of a detected road bump, for example, may thus be ascertained and corresponding information may be output only if the road bump reaches or exceeds a previously established minimum height. In this way, warning signals for minor road bumps may be suppressed, so that endangering or irritating the driver due to unnecessarily displayed information about non-dangerous road bumps is avoided and the acceptance of a warning system for executing the method according to the present invention is enhanced.

It is furthermore advantageous in particular if at least after passing over a detected road bump, the road contact of at least one axle of the vehicle is monitored and if one or both axles of the vehicle have lost contact with the road, a braking command that might have been actuated by the driver is ignored by a control unit and the brake remains released until the road contact on the at least one axle, preferably on all axles, of the vehicle is restored. Such an extended automatic function may help avoid major damage which might occur if a driver briefly loses road contact after driving over a road bump too fast and operates the brake during this time, so that the subsequent landing takes place with blocked wheels, which results in maximum stress in particular for the suspension mounting.

The object detector used for carrying out the method according to the present invention may be advantageously formed by video sensors and/or radar sensors and/or lidar sensors and/or laser sensors and/or ultrasonic sensors. When road bumps are detected by optical systems such as video cameras or image sensors, it may be advantageously taken into account that road bumps are mostly marked by a continuous white or yellow line over the top of the road bump. This line of a road bump has, unlike other lines such as stop lines, a different shape; for example, it may have a zig-zag shape. It may also be broken or continuous. A stop line is often narrower and, mainly, oriented perpendicularly to the road.

A line detected by a video sensor is then identified using an image processing algorithm. Algorithms similar to those used for lane recognition in a Lane Departure Warning System (LDW) may be used for this purpose, which detect gray value edges, for example, via gray value detection. These edges represent the boundary of the road bump line. However, contrary to LDW, the search direction is exactly orthogonal, i.e., the search direction is in the direction of the roadway; in contrast, the road bump boundary runs approximately across the roadway. The interpolation points thus found are then merged via an estimation method (e.g., Kalman filter) to form a road bump contour and subsequently compared with predefined templates (e.g., of a zig-zag contour) to determine whether or not there is a road bump. When a color camera is used, the color of the road bump boundary may be additionally used as a detection criterion.

When detecting with the aid of radar sensors, either long-range radar sensors (LRR sensors, for example, working with 77 GHz) or short-range radar sensors (SRR sensors), which may also be used as a stop-and-go accessory for ACC systems (Automatic Cruise Control), may be used. Furthermore, lidar sensors or lidar scanners may also be used, which are also utilized for ACC systems. Road bumps are detected as very wide stationary obstacles having a rather moderate radar/lidar back-scatter cross section.

Road bumps may also be detected as obstacles with the aid of ultrasonic sensors, which are used, for example, for functions of a parking pilot. However, the forward-looking range, a maximum of 5 m, is relatively limited, so that in many cases the driver is no longer able to react to the warning in a timely manner.

In contrast, a combination of the above-mentioned sensors is advantageous in particular. The detection reliability may be significantly increased by a combination of multiple sensor principles. A road bump detected by an LRR sensor may thus be advantageously verified by a video sensor.

In general, all types of sensors may be used which are capable of detecting obstacles for which features for identifying a road bump may be derived.

It is furthermore advantageous in particular if information regarding positions of known road bumps is provided in digital form and the instantaneous position of the vehicle is determined with the aid of a position finding device, the digital information, in combination with the instantaneous vehicle position, being supplied to the evaluation unit for ascertaining the road bumps in front of the vehicle. When these digital data, which may be available in particular within a navigation system, are combined with the data of the object detection means by merging data, the reliability and/or accuracy in detecting road bumps may be further enhanced. Basically it is, however, also possible that the road bumps are detected and the associated information is output to the driver and/or to components of the vehicle solely on the basis of the digital data in combination with the instantaneous vehicle position. For this purpose, the object detector is formed by a navigation system which includes, on the one hand, an arrangement for determining the instantaneous vehicle position and, on the other hand, a database as a digital map which contains information about known road bumps, including their particular positions, in addition to information regarding different objects such as traffic signs or buildings. The corresponding information regarding positions of known road bumps is extracted from the digital database as a function of the instantaneous position of the vehicle.

The present invention furthermore relates to a system for assisting the driver of a vehicle in identifying road bumps which is suitable for carrying out the method according to the present invention.

A driver assistance system corresponding to the example method described previously includes object detector for detecting objects located outside a vehicle, an evaluation unit capable of evaluating the detected objects for the presence of defined features, and a control or regulating unit for generating information which may be output to the driver and/or to certain components of the vehicle, the evaluation unit being suitable for evaluating detected objects for agreements with road bumps, and the information for the driver and/or for the components of the vehicle is output as a function of a positive result of this evaluation. The evaluation unit on the one hand and the control or regulating unit on the other hand may also advantageously be combined or integrated into each other.

### BRIEF DESCRIPTION OF THE DRAWINGS

An exemplary embodiment of the present invention is depicted in the figures and explained in detail below:

FIG. 1 schematically shows a vehicle equipped with an example system according to the present invention.

FIG. 2 schematically shows the example system according to the present invention.

### DETAILED DESCRIPTION OF EXAMPLE EMBODIMENTS

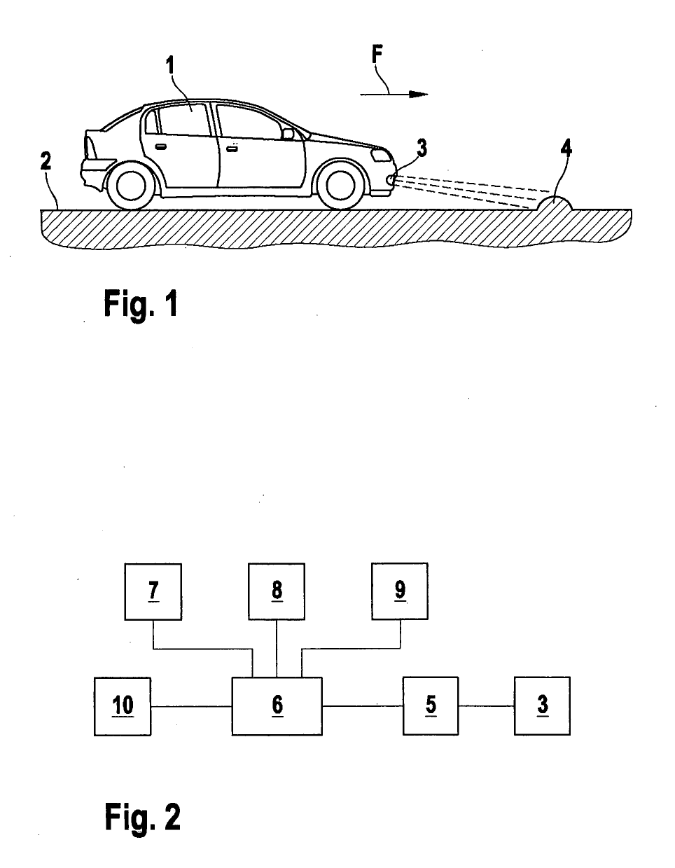

The example method according to the present invention and the example system according to the present invention are used in particular in motor vehicles. FIG. 1 shows a motor vehicle 1, which moves on a road 2 in a driving direction F illustrated by an arrow. In the front area of motor vehicle 1, a sensor 3 is situated for detecting objects in front of motor vehicle 1 on road 2. Sensor 3 is a video sensor in this case. Sensor 3 detects road bumps 4, which are intentionally built into road 2 for speed reduction (FIG. 1).

The data detected by sensor 3 are supplied to an evaluation unit 5, which ascertains, at least with a high probability, whether or not the object detected by sensor 3 is a road bump 4 using optical image processing algorithms.

Evaluation unit 5 is connected to a control unit 6, which activates a visual 7 and/or acoustic 8 and/or haptic 9 warning signal generating means as a function of the result ascertained by evaluation unit 5, when a detected object is identified as a road bump 4 (FIG. 2).

Control unit 6 may also provide information to certain components 10 of motor vehicle 1 when a road bump 4 has been detected. These components 10 may be, for example, a control device for the drive and/or for the brakes of motor vehicle 1, so that motor vehicle 1 may be automatically braked if a road bump 4 has been detected. If motor vehicle 1 has an active chassis, components 10 activatable by control unit 6 may also be a control device of the active chassis, for pre-tensioning the active chassis, i.e., setting it for subsequently driving over a road bump 4.

What is claimed is:

1. A method for assisting a driver of a vehicle in identifying an obstacle for the vehicle, the method comprising:
detecting objects located outside the vehicle using an object detector;
ascertaining whether a detected object is a road bump; and
outputting information to at least one of the driver and a defined component of the vehicle only if the detected object is a road bump.

2. The method as recited in claim 1, wherein the output of information to the at least one of the driver and the component of the vehicle if a road bump has been detected is suppressed if an instantaneous speed of the vehicle at least one of is lower than a predefined maximum speed, and the vehicle is braked by the driver.

3. The method as recited in claim 1, further comprising:
automatically reducing a speed of the vehicle if a road bump has been detected.

4. The method as recited in claim 3, wherein the speed of the vehicle is automatically reduced by braking to a predefined maximum speed.

5. The method as recited in claim 4, wherein a height of a detected road bump is ascertained, and the maximum speed is a function of the height of the detected road bump.

6. The method as recited in claim 1, wherein, if a road bump has been detected, at least one of an active chassis of the vehicle is automatically adjusted, a ground clearance of the vehicle is increased, and a suspension is set to be softer.

7. The method as recited in claim 4, wherein a drive of the vehicle is controlled in such a way that after passing a detected road bump, and after input of a signal by the driver, the vehicle is accelerated again, the operating parameters which existed before the detection of the road bump being reset.

8. The method as recited in claim 6, wherein the active chassis is controlled in such a way that after passing a detected road bump, and after input of a signal by the driver, the active chassis is set again to a road bump-free stretch.

9. The method as recited in claim 1, wherein, if a road bump has been detected, at least one of a visual acoustic, and haptic warning signal is generated for the driver.

10. The method as recited in claim 1, wherein, if a road bump has been detected, an automatic braking jolt is generated.

11. The method as recited in claim 1, wherein, when a road bump is detected, a picture or a symbol of a road bump is inserted into a video display system of the vehicle, the picture or symbol being highlighted by a marking.

12. The method as recited in claim 1, wherein a height of a detected road bump is ascertained, the ascertained height is compared to a comparison value, and the information output to the at least one of the driver and the component of the vehicle is a function of a result of the comparison.

13. The method as recited in claim 1, wherein, after passing over a detected road bump, a road contact of the vehicle is monitored, and if road contact on at least one axle of the vehicle is lost, a braking command that was issued by the driver is ignored until the ground contact on the at least one axle is restored.

14. The method as recited in claim 1, wherein the object is detected using at least one of video sensors, radar sensors, lidar sensors, laser sensors, and ultrasonic sensors.

15. The method as recited in claim 1, wherein digital information regarding positions of known road bumps is provided, and an instantaneous position of the vehicle is determined using a position finding device, the digital information, in combination with the instantaneous vehicle position, being supplied to an evaluation unit.

16. A driver assistance system, comprising:
an object detector adapted to detect objects located outside a vehicle;
an evaluation unit adapted to evaluate detected objects for a presence of defined features; and
a control unit adapted to generate information capable of being output to at least one of a driver and a defined component of the vehicle;
wherein the evaluation unit is adapted to evaluate detected objects for agreement with road bumps, and the information for at least one of the driver and the component of the vehicle is generated as a function of a positive result of the evaluation.
